(19) United States
(12) Patent Application Publication
(10) Pub. No.: US 2014/0100771 A1
(43) Pub. Date: Apr. 10, 2014

(54) METHOD AND APPARATUS FOR SYNCHRONIZED NAVIGATION BY MOBILE AGENTS

(71) Applicants: FRANK EDUGHOM EKPAR, AIZUWAKAMATSU CITY (JP); GRACE EKAETE EKPAR, AIZUWAKAMATSU CITY (JP)

(72) Inventors: FRANK EDUGHOM EKPAR, AIZUWAKAMATSU CITY (JP); GRACE EKAETE EKPAR, AIZUWAKAMATSU CITY (JP)

(21) Appl. No.: 13/645,452

(22) Filed: Oct. 4, 2012

(51) Int. Cl. G01C 21/00

(52) U.S. Cl. 701/408; 701/400

(57) ABSTRACT

The present invention discloses methods, systems and devices for synchronized navigation of an environment by a plurality of mobile agents wherein aspects of the navigation of one or more of the agents are used to moderate aspects of the navigation of one or more other agents. In one embodiment, two mobile agents—a baby stroller and a caregiver—are configured in a manner that facilitates tandem navigation of the environment by the mobile agents. In yet another embodiment, a wheelchair designed to transport a disabled person navigates in tandem with a guide such as a human guide, a guide dog or any other suitable agent. Other embodiments including an entertainment application in which a mobile agent follows or leads another are also disclosed.

### CROSS-REFERENCE TO RELATED APPLICATIONS

This United States (U.S.) Non-Provisional application claims the benefit of U.S. Provisional Application Ser. No. 61/624,366, filed on Apr. 15, 2012, herein incorporated by reference.

### BACKGROUND OF THE INVENTION

1. Field of the Invention

The present invention relates generally to the field of navigation by mobile agents. More specifically, the present invention is directed towards methods, systems and devices for synchronized navigation of an environment by a plurality of mobile agents wherein aspects of the navigation of one or more of the agents are used to moderate aspects of the navigation of one or more other agents.

2. Description of the Prior Art

A very wide variety of application domains involve synchronized navigation of an environment by a plurality of mobile agents. In this context, a mobile agent is any entity capable of movement or that can change its location within its environment. One well-known application is the situation where a caregiver takes a baby for a stroll in a stroller. The prior art requires the caregiver to push the stroller manually to navigate the environment in order to effect the stroll. In addition to the demands this places on the caregiver, this configuration limits interaction between the baby in the stroller and the caregiver with a resultant decrease in opportunities for nurturing behavior by the caregiver. Another application is the situation where a disabled person uses a wheelchair or any other suitable transport for navigation. While some disabled persons are capable of steering the wheelchair (or other suitable transport) themselves, the blind generally need a guide for navigation. The prior art severely limits the choice of guide in these circumstances—typically requiring another sighted human agent to operate the wheelchair (or other suitable transport) for the blind. Use of a guide dog or other options that would afford the disabled person a greater level of independence from other human agents are virtually precluded by the prior art. Although applications where a convoy of mobile agents navigates under the leadership of one of the agents in the convoy exist, flexibility in the positioning and roles of the agents is limited. For example, U.S. Pat. No. 7,593,811 discloses a method and system for following a lead vehicle. More flexible contemporary convoy navigation systems such as those disclosed in U.S. Pat. No. 8,116,921 require a tether between the leader and the follower and thus constrain the level of interactivity between entities transported on the vehicles in the convoy. Even when a tether is not required and greater flexibility in the configuration of vehicles is permitted by the prior art (as in the mine vehicle convoys described in U.S. Pat. No. 7,831,345), the prior art is still limited to one kind of mobile agent—in the case of the mine vehicle convoy system the agent being a mine vehicle with or without a human operator.

### SUMMARY OF THE INVENTION

It is an object of the present invention to overcome the limitations of the prior art set forth above by providing methods, systems and devices for synchronized navigation of an environment by a plurality of mobile agents wherein aspects of the navigation of one or more of the agents are used to moderate aspects of the navigation of one or more other agents. In one embodiment, two mobile agents—a baby stroller and a caregiver—are configured in a manner that facilitates tandem navigation of the environment by the mobile agents. In yet another embodiment, a wheelchair designed to transport a disabled person navigates in tandem with a guide such as a human guide, a guide dog or any other suitable agent. The present invention allows for greater interaction between the mobile agents and permits a miscellaneous assortment of mobile agents to navigate the environment in a synchronized manner.

### BRIEF DESCRIPTION OF THE DRAWINGS

FIG. 1 illustrates an embodiment of synchronized navigation of an environment by two mobile agents.

FIG. 2 shows a flowchart outlining how a follower mobile agent could navigate in response to navigation by a lead mobile agent.

### DETAILED DESCRIPTION OF THE PREFERRED EMBODIMENTS

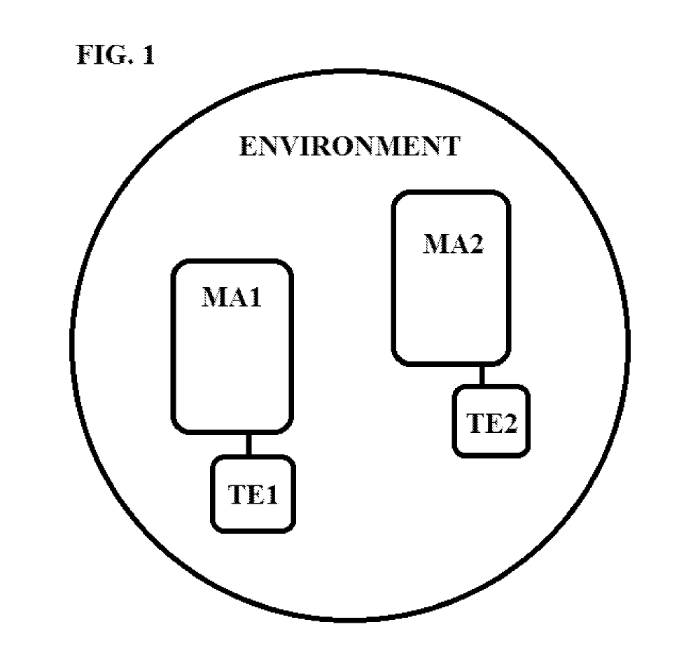

FIG. 1 depicts two mobile agents navigating in an environment labeled ENVIRONMENT—which could be part of a road, a side walk, playground, a factory floor or any other suitable environment. MA1 represents a first mobile agent while MA2 represents a second mobile agent. In the application where a caregiver takes a baby in a baby stroller for a stroll, MA1 could represent the caregiver. The caregiver could be a parent, relative, nanny or any other caregiver for the baby. MA2 could represent the baby stroller in which the baby is transported. The stroller could be fitted with an engine, wheels or any other suitable systems for locomotion. Furthermore, the stroller could be adapted for steering via reception of suitable control signals from a control unit embedded in the stroller and operated remotely or autonomously via processing of suitable control signals. TE1 is a tracking element connected operatively to mobile agent MA1 while TE2 is a tracking element connected operatively to mobile agent MA2. In this context, a tracking element is any method, system or device (or combination of methods, systems and/or devices) that facilitates the determination of the location of and tracking of the position of the mobile agent and/or the determination of any other suitable characteristic (such as color, texture, state, and so on) of the agent. This could involve tracking the position (relative to a chosen reference point) and direction of motion of the mobile agent at desired times. In the case of the baby stroller and caregiver, the tracking element on the caregiver—TE1—could be a system such as a radio frequency identification (RFID) tag and associated systems, a global positioning system device (GPS) and associated systems, simply the body of the caregiver or any other suitable tracking method, system or device. Similarly, the tracking element on the stroller carrying the baby—TE2—could be a system such as a RFID tag and associated systems, a GPS device and associated systems, simply the body of the stroller or any other suitable tracking method, system or device. One of ordinary skill in the art would appreciate that the tracking elements could be positioned in such a way as to facilitate the determination of the position and/or direction/speed of motion (or any other desired position/motion characteristic) of the first mobile agent with respect to the second mobile agent. For example, when RFID tags and associated systems such as radio-frequency transceivers are used, triangulation algorithms could be used to determine the relative positions of the first and second mobile agents. A passive or active RFID tag could be placed on the caregiver—MA1—while a suitable number of associated radio-frequency transceivers are placed on the stroller—MA2 to enable the determination of the position of the caregiver relative to the stroller. Global Positioning System (GPS) units could also be incorporated in the tracking elements TE1 and TE2 to track the locations of the mobile agents MA1 and MA2. Tracking information could also be obtained by using suitable imaging devices such as cameras in conjunction with image processing and computer vision algorithms to locate and track mobile agents. This information could be used by a control unit embedded in the stroller to determine how to move the stroller to maintain any desired separation between stroller and caregiver. Movement of the stroller could occur automatically by sending appropriate steering signals to the control unit on the stroller. The steering unit could then issue the appropriate steering commands to the stroller to cause the stroller to move appropriately. Alternatively, the caregiver could operate the stroller remotely by manually checking the position of the stroller and moving it appropriately—when necessary—to position it as desired. Remote control could be achieved wirelessly using infrared signals, radio waves, sound waves, light or via any other suitable mechanism such as wires connected operatively to control switches on a control unit held by the caregiver. Preferably, the stroller could move automatically by monitoring the position of the caregiver and processing the position information into suitable steering signals which are used to steer the stroller appropriately based on a desired separation between stroller and caregiver. The desired separation could be set on the control unit (preferably with the possibility of dynamic adjustment by the caregiver) and as the caregiver moves around the environment, the stroller moves in tandem automatically while maintaining the desired separation between the caregiver and stroller. The caregiver could be in front of the stroller, behind the stroller or on either side of the stroller as desired. A scenario could be envisioned in which the system incorporates a mechanism for switching between automatic navigation mode and manual navigation mode (where the caregiver reverts to traditional methods of navigation such as pushing of the stroller by hand) as desired.

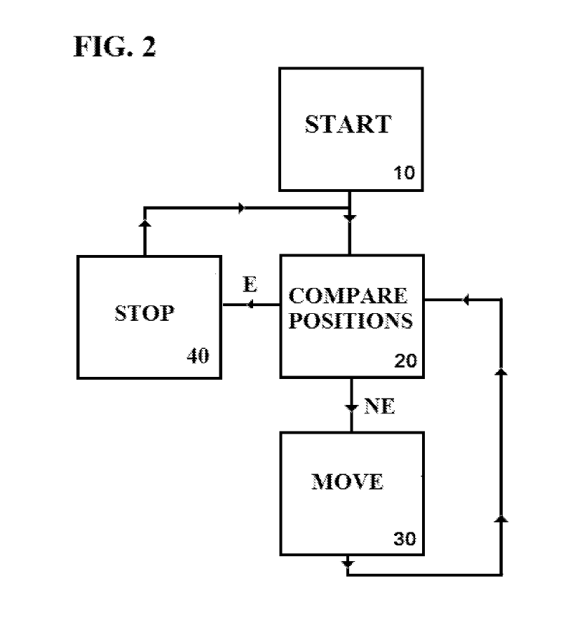

The flowchart in FIG. 2 illustrates how a follower (second) mobile agent could navigate in response to navigation by a lead (first) mobile agent. Note that in this and similar scenarios the first agent could act as a reference for control signals or for moderation of the navigation or other relevant behavior of other agent(s) while the second agent could act as the target for control signals or for moderation of the navigation or other relevant behavior of other agent(s) and vice-versa. In the case of a baby stroller and a caregiver (labeled MA2 and MA1, respectively, in FIG. 1) the follower mobile agent MA2 (baby stroller) starts by carrying out the method or process depicted as START, 10, in FIG. 2 which effectively initializes the agent. This could involve making sure that it is stationary (when required by the design of the system and safety considerations) and collecting data from the tracking element (TE2 in FIG. 1) to determine its position relative to the caregiver—MA1 in FIG. 1. Next, the second mobile agent compares its position with the position of the first mobile agent as part of the COMPARE POSITIONS, 20, step. If the result of this comparison is E (meaning both agents are positioned as expected with respect to the desired separation) then the second agent executes the STOP, 40, step and stops moving or reverts to a predetermined state. If, however, the result of the comparison is NE (meaning the agents are not positioned as expected with respect to the desired separation) then the second agent executes the MOVE, 30, step and moves appropriately or changes to a desired new state to ensure that its position relative to the first mobile agent is as expected based on the desired separation between the agents. The direction, speed, duration or any other relevant characteristics of the movement are informed by the results of the position comparison step and/or the overall design of the system and safety or other relevant considerations. More specifically, the first agent could move towards, away from or alongside the second agent as required. Any other suitable patterns of movement could be executed as required by the application. Furthermore, the second mobile agent could be equipped with obstacle detection sensors or systems for avoiding intervening obstacles on the path while moving into position to satisfy the separation requirements. The process could be repeated as desired to accomplish set goals possibly starting with the COMPARE POSITIONS, 20, step and proceeding with subsequent steps for any number of desired iterations. Repetition of any of the steps in the process could also be triggered by events adapted to act as triggers for the execution of the steps desired to accomplish set goals such as the successful navigation of a given environment.

Control of the second mobile agent in response to tracking signals from a first mobile agent could be effectuated using a dedicated control unit that receives the tracking signals, processes or interprets the signals and generates appropriate control signals that could be used to steer the second mobile agent. The control unit could be part of the steering system on the second mobile agent or separate from it but connected operatively to it to enable control signals to be utilized for steering. Alternatively, the control unit could be located outside the second mobile agent and adapted to transmit suitable control signals to the second mobile agent via a suitable medium such as radio waves, infrared signals, sound waves as in sonar, the Internet or any other suitable means. An existing steering system on the second mobile agent could be adapted to incorporate signals from the control unit in steering the second mobile agent or the steering system could be designed explicitly to respond appropriately to the control signals from the control unit. Parts of the control unit could be implemented as software running on a suitable computing platform or as hardware or as a combination of software and hardware components.

Tracking could be based on radio waves, RFID systems, infrared signals, vision (using cameras and/or appropriate image processing/computer vision systems), GPS devices and associated systems, light, radar, laser, sound waves as in sonar, manual inspection via human sight or any other suitable means.

In the baby stroller and caregiver example, the present invention enhances interaction between the baby in the stroller and the caregiver with a resultant improvement in opportunities for nurturing behavior by the caregiver and a more enjoyable strolling experience for both caregiver and baby.

An arrangement similar to that used in the case of a baby stroller and caregiver could be used in the case of a blind person in a wheelchair and a guide. The guide could be a sighted person, trained guide dog or any other suitable agent. When RFID tags and associated systems are used for tracking, passive or active tags could be worn by the guide while suitable transceivers could be located on the wheelchair and triangulation or other suitable algorithm applied to the radio signals to determine position data which could subsequently be transformed into control signals for automatically steering the wheelchair as appropriate. GPS units and associated systems could also be employed and used to generate the control signals for automatic steering where appropriate. Alternatively, the guide could use a wired or wireless remote control unit to steer the wheelchair as appropriate.

In an entertainment application, the first mobile agent could be a person while the second mobile agent could be a suitable locomotive such as a toy car or any other suitable device or system. The system could be configured in a manner that permits the second mobile agent to follow the person as the person runs, walks, strolls or generally moves within the environment. Alternatively, the second mobile agent could lead the person—creating the impression of avoiding or moving away from the person or first mobile agent as the person runs, walks or generally moves towards the second mobile agent. Any of the tracking and control systems discussed previously for other applications such as that of a baby stroller and caregiver including GPS units could also be used for tracking and control in entertainment applications.

Computer software could also be written to incorporate the methods, algorithms and systems disclosed in the present invention to provide numerous avenues for training, entertainment and other uses of the present invention. For entertainment purposes, computer game software running on a suitable system such as a personal computer running Microsoft Windows, Apple, Google Android or other suitable operating system and associated hardware and/or software components could incorporate the methods, algorithms and systems disclosed in the present invention to create a game in which different parties could simultaneously or separately play the roles of first and second or leader and follower agents via suitable avatars within the software and suitable display and/or control devices or systems. Simulations of aspects of the methods, algorithms and systems disclosed in the present invention could also be used for training or other suitable purposes either towards the operation of actual systems and devices based on the methods, algorithms and systems disclosed in the present invention or towards related applications in any suitable field. Such computer software and simulations could be written in any suitable programming language such as C, C++, JAVA, C#, HTML5, VRML, and so on, and using any suitable tools or components—including any suitable hardware and/or software tools, components or systems.

According to the principles of the present invention, control of aspects of one agent via aspects of another agent need not be limited to characteristics such as the location, speed, direction or movement or state of movement (for example stationary or in motion) of the agents but could be based on any suitable aspect of the agents that could possibly influence any suitable aspects of other agents. For example, the color, texture and any other relevant characteristics of avatars used to represent agents in a computer software game or simulation could be used to moderate desired aspects of other agents. The specific characteristics chosen to moderate aspects of agents depend on the specific requirements of a given application of the invention.

The foregoing embodiments utilized two mobile agents navigating an environment in tandem. However, the principles of the present invention permit an arbitrary number of mobile agents to navigate in a synchronized manner. One of the mobile agents could be designated as the leader while the others act as followers and navigate in a manner that allows them to maintain a desired separation from the leader and/or each other. Alternatively, each agent could adopt the nearest agent in the group or convoy as its leader and navigate based on the position of its neighbor. Other configurations are possible. In particular, there is no limitation on the location of the leader relative to a follower or followers.

So far systems in which there is no mechanical connection, harness or tether between the mobile agents have been considered. Although such systems are preferable for the obvious advantages they offer with respect to alternative systems requiring the use of a mechanical connection, harness or tether between the mobile agents, the present invention permits the use of such connections between mobile agents where appropriate. In the case of the baby stroller and caregiver, a flexible harness or tether such as a rope could be attached to the stroller at a suitable attachment point with the other end held or attached to the body of the caregiver. The caregiver could then move freely—dragging the stroller along. Alternatively, a more rigid harness or tether could be used permitting the caregiver to “push” the stroller from behind or drag it along with the caregiver in front of the stroller as desired. Existing systems relying on such connections are limited by the types of mobile agents permitted—usually one type of mobile agent. In contrast, the present invention permits the use of a miscellaneous assortment of mobile agents moving in synchrony with or without such connections.

Although mobile agents have been used to illustrate the principles of the present invention, it should be understood that the agents involved need not be mobile. At least one of the agents could be fixed in space. In such situations, signals to and/or from the fixed mobile agent could be used to moderate the position and/or any other desired aspects of any other agent.

It should be understood that numerous alternative embodiments and equivalents of the invention described herein may be employed in practicing the invention and that such alternative embodiments and equivalents fall within the scope of the present invention.

What is claimed is:

1. An apparatus for synchronized navigation of an environment comprising: at least one first agent and at least one second agent wherein at least one aspect of the navigation of at least one of the agents is used to moderate at least one aspect of the navigation of at least one other agent.

2. The apparatus of claim 1 wherein the first agent is a leader and the second agent is a follower.

3. The apparatus of claim 2 wherein the location of the first agent is used to moderate the location of the second agent.

4. The apparatus of claim 3 wherein determination of the location of an agent is via the use of electromagnetic signals.

5. The apparatus of claim 3 wherein determination of the location of an agent is via the use of optical signals.

6. The apparatus of claim 3 wherein determination of the location of an agent is via the use of sound signals or sound waves.

7. The apparatus of claim 2 wherein the first agent is a caregiver and the second agent is a baby stroller.

8. The apparatus of claim 2 wherein the first agent is a guide (such as a human guide or a guide dog) and the second agent is a wheelchair such as one designed to transport a disabled person.

9. The apparatus of claim 2 wherein the first agent is a person and the second agent is a locomotive such as a toy car.

10. The apparatus of claim 2 wherein the first agent is a locomotive such as a toy car and the second agent is a person.

11. A method for synchronized navigation of an environment by at least one first agent and at least one second agent wherein at least one aspect of the navigation of at least one of the agents is used to moderate at least one aspect of the navigation of at least one other agent, said method comprising steps of:
a) selecting and initializing at least one reference agent and at least one target agent;
b) tracking the position or other selected characteristic of at least one reference agent and at least one target agent;
c) comparing the position or other selected characteristic of at least one reference agent to the position or other selected characteristic of at least one target agent;
d) setting at least one agent in a predetermined state such as a stationary state if the result of the position or other selected characteristic comparison in step c indicates that the agents are positioned as expected or have some other selected characteristic;
e) setting at least one agent in a new state such as a state of motion designed to facilitate an expected position configuration if the result of the position or other selected characteristic comparison in step c indicates that the agents are not positioned as expected or do not have some other selected characteristic;
f) repeating step b to step f as appropriate based on the design and configuration of the agents.

12. The method of claim 11 wherein the first agent is a leader and the second agent is a follower.

13. The method of claim 12 wherein the location of the first agent is used to moderate the location of the second agent.

14. The method of claim 13 wherein determination of the location of an agent is via the use of electromagnetic signals.

15. The method of claim 13 wherein determination of the location of an agent is via the use of optical signals.

16. The apparatus of claim 13 wherein determination of the location of an agent is via the use of sound signals or sound waves.

17. The method of claim 12 wherein the first agent is a caregiver and the second agent is a baby stroller.

18. The method of claim 12 wherein the first agent is a guide (such as a human guide or a guide dog) and the second agent is a wheelchair such as one designed to transport a disabled person.

19. The method of claim 12 wherein the first agent is a person and the second agent is a locomotive such as a toy car.

20. The method of claim 12 wherein the first agent is a locomotive such as a toy car and the second agent is a person.

21. The method of claim 11 wherein at least one agent is implemented as a software component.

22. The method of claim 21 wherein the resulting system is used for training purposes.
